(19) United States
(12) Patent Application Publication
(10) Pub. No.: US 2025/0273901 A1
(43) Pub. Date: Aug. 28, 2025

(54) Support Sleeve Assembly, Cable Plug-Connector Arrangement, Modular System, and Method for Assembling a Support Sleeve Assembly

(71) Applicant: Rosenberger Hochfrequenztechnik GmbH & Co. KG, Tittmoning (DE)

(72) Inventors: Hubert Speckbacher, Fridolfing (DE); Thomas Mayer, Fridolfing (DE)

(21) Appl. No.: 19/065,032

(22) Filed: Feb. 27, 2025

(30) Foreign Application Priority Data
Feb. 28, 2024 (DE) 10 2024 105 625.8

(51) Int. Cl. H01R 13/58; H01R 13/02; H01R 24/54; H01R 24/56

(52) U.S. Cl. CPC H01R 13/5825; H01R 13/025; H01R 24/542; H01R 24/56

(57) ABSTRACT

A support sleeve assembly (1) for fastening on a cable (5), in particular on an electrical cable (5) for high-voltage engineering, has an external element (2) which is formed from a metal sheet, and at least one adapter element (3) comprising a plastics material. The external element (2) is formed so as to be at least partially annular. The at least one adapter element (3) is received within the external element (2) and is captively fastened to the external element (2).

Support sleeve assembly, cable plug-connector arrangement, modular system, and method for assembling a support sleeve assembly

The invention relates to a support sleeve assembly for fastening on a cable, in particular on an electrical cable for high-voltage engineering. having an external element which is formed from a metal sheet, and at least one adapter element comprising a plastics material.

The invention moreover relates to a cable plug-connector arrangement having a support sleeve assembly and a cable, in particular a high-voltage cable, wherein the support sleeve assembly is disposed on an end portion of the electrical cable.

The invention furthermore relates to a modular system and to a method for assembling the support sleeve assembly.

When fabricating cables, the conductors of the latter are typically connected to contact elements of a plug connector. In the later use of the plug connector, these contact elements serve to contact corresponding mating contact elements of a mating plug connector. For this purpose, a connection which is reliable or robust in mechanical and electrical terms and moreover durable is to be implemented between the cable components and the plug-connector components, so that the plug connector is suitable for as many plugging cycles as possible, and also suitable for use in adverse environmental conditions. Last but not least, it should also be ensured in particular that the electrical and mechanical connection between the cable components and the plug-connector components is not unintentionally released under transverse and/or longitudinal tension on the cable.

A support sleeve is typically used for fixing a cable shield, or an outer conductor of the cable, to an outer conductor contact element of the plug connector. For this purpose, the cable shield is typically fastened in a force-fitting and/or form-fitting manner, in particular clamped, between the support sleeve and the outer conductor contact element. This is in practice in most instances implemented by press-fitting or crimping the outer conductor contact element on the support sleeve. As a result, the support sleeve, proceeding from its mechanically relaxed state, is compressed, this generating an elastic pre-load in the support sleeve Inter alia as a result of this restoring force, or spring force, of the support sleeve, the cable shield is ultimately fixed to the outer conductor contact element in a mechanically and electrically sufficiently stable manner.

Support sleeves are typically designed as turned metallic parts. preferably made of a non-ferrous metal (such as, for example, brass or bronze) or from spring steel, for example. Based on experience, support sleeves of this type are particularly suitable for the deformation required in the context of the crimping process and for a long service life. However, the production of the known support sleeves is cost-intensive and complex, which is an obstacle in terms of the additional requirement that the plug connectors are able to be economically produced in the context of mass production.

In particular, metal sleeves of different sizes are to be manufactured for different cable diameters, often having a consistent external diameter but an internal diameter which is adapted to the respective cable cross section. This can result in particular that support sleeves have to be provided with a very large wall thickness in the case of small cable diameters. This causes high material costs, and it is thus possible to fasten the support sleeves to the cable in the context of the crimping process only by applying a very high force.

With a view to the known prior art, the object of the present invention lies in providing a support sleeve assembly having advantageous properties for fixing a cable shield in the context of fabricating a cable, said support sleeve being in particular able to be produced and assembled in a cost-effective manner in the context of mass production, and preferably being adaptable to different cable diameters using simple technical means

The present invention is also based on the object of providing a cable plug-connector arrangement which has a mechanically and/or electrically advantageous support sleeve for fixing a cable shield to an outer conductor contact element, and is in particular able to be produced and assembled in a cost-effective manner in the context of mass production. and is preferably adaptable to different cable diameters using simple technical means.

Finally, it is also an object of the invention to provide a modular system and a method in order to produce and to assemble an electrically and mechanically advantageous support sleeve assembly, in particular in a cost-effective manner in the context of mass production, and to adapt said support sleeve assembly to different cable diameters using simple technical means.

In terms of the support sleeve assembly, the object is achieved by the features set forth in claim 1. In terms of the cable plug-connector arrangement, the object is achieved by the features of claim 17. In terms of the modular system, the object is achieved by claim 19, and in terms of the method achieved by claim 20.

The dependent claims and the features described hereunder relate to advantageous embodiments and variants of the invention.

The invention relates to a support sleeve assembly for fastening directly or indirectly on a cable, in particular on an electrical cable, preferably an electrical cable for high high-voltage engineering. The invention will be described hereunder substantially for use with an electrical cable, which however is not to be understood to limit the invention, because the support sleeve assembly can also be suitable for fastening on an optical cable, for example.

The support sleeve assembly is preferably provided for fixing a cable shield of the cable in a force-fitting and/or form-fitting manner. It can be provided in particular that the cable shield is able to be fixed, in particular clamped, in a force-fitting and/or form-fitting manner between the support sleeve assembly and an outer conductor contact element, yet to be mentioned hereunder.

The electrical cable is not to be understood as part of the support sleeve assembly according to the claims. However, the applicant reserves the right to claim arbitrary combinations of the support sleeve assembly, the cable shield, the cable, the outer conductor contact element and/or the plug connector, or said subject matter in each case individually or separately, wherein the individual features of said subject matter described hereunder are able to be combined with one another in a corresponding manner.

The support sleeve assembly can also be referred to hereunder as a plug-connector component of the plug connector (apart from further optional plug-connector components). The support sleeve assembly is preferably able to be used like a conventional support sleeve and can therefore also be referred to as “support sleeve”. The chosen term “support sleeve assembly” is essentially intended to emphasise the fact that the “support sleeve” is in multiple parts, as described hereunder.

The support sleeve assembly can be designed to receive an end portion of the cable. The end portion of the cable, which is provided to be received in the support sleeve assembly. can in particular be the end portion of the cable on which the plug connector already mentioned above is to be assembled. The support sleeve assembly is preferably positioned at a defined axial position of the end portion of the cable, so that the cable extends completely through the support sleeve assembly.

It can be provided that a cable sheath of the cable ends within the support sleeve assembly, so that the support sleeve assembly is preferably able to be fastened at least in portions on the cable sheath, in particular able to be press-fitted or crimped on the cable sheath.

The support sleeve assembly can have a detent on which the end of the cable sheath facing the support sleeve assembly abuts in such a way that the support sleeve assembly is able to be axially positioned, or aligned, optimally relative to the end of the cable sheath. The collar yet to be mentioned hereunder, or the collar segments of the support sleeve assembly, can be suitable for this purpose, for example,

The cable sheath does not necessarily have to do end within the support sleeve assembly. For example, it can also be provided that the cable sheath extends completely through the support sleeve assembly, or that the support sleeve assembly directly adjoins the cable sheath along the longitudinal axis of the cable.

The end portion of the cable that is provided for fastening in the support sleeve assembly can be untreated, but typically already be partially prefabricated/pre-machined, when the support sleeve assembly is being assembled. It can be provided in particular that the end portion of the cable is exposed at least in portions so that one or a plurality of cable components of the cable is/are at least partially stripped and accessible for connecting to the plug-connector components. For example, it can be provided that, proceeding from a front plug-proximal end, one or a plurality of inner conductors of the cable are stripped at least in portions of an encasing dielectric. Furthermore, the cable shield of the cable can be at least partially stripped of an outer sheathing and/or shielding foil, so that said cable shield is accessible for fixing between the support sleeve assembly and the outer conductor contact element.

The cable shield can in particular be a braided cable shield of the cable, thus in particular a braid made of intertwined individual wires. In principle, the term “cable shield” may however be understood to relate to any type of outer conductor of the cable, thus in particular also to a shielding foil, or a combination of braided cable shield and shielding foil.

In principle, the proposed support sleeve can be suitable for use with any arbitrary electrical or optical cable. Provided inter alia in the context of the invention can be an electrical cable which has an arbitrary number of inner conductors, or cable cores. For example, an electrical cable in the context of the invention can have one inner conductor, two inner conductors, three inner conductors, four inner conductors or even more inner conductors. Preferably, an electrical cable having exactly one inner conductor or exactly two inner conductors is provided. If a cable having only one inner conductor is provided, this can be designed as a coaxial cable. If an electrical cable having more than one inner conductor is provided, the cable cores of the cable can be twisted in the manner of a “twisted pair” cable; however, the cable cores can also extend in parallel, as in a “parallel pair” cable, for example.

By means of the proposed support sleeve assembly, the cable shield of the electrical cable can advantageously be fixed on the outer conductor contact element of the electrical plug connector to be assembled on the corresponding cable end of the cable.

According to the invention, the support sleeve assembly has an external element which is formed from a metal sheet, and at least one adapter element comprising a plastics material. The external element is formed so as to be at least partially annular. The at least one adapter element is received within the external element and is captively fastened to the external element.

As a result of the proposed combination of an external element formed from a metal sheet and an adapter element which is made of a plastics material and received within the metal sheet, the complexity in terms of production for the support sleeve assembly can be substantially improved in economic and technical terms.

In particular, always the same external elements can be used independently of the cable diameter of the cable provided for use with the support sleeve assembly, said external elements being able to be produced in a cost-effective manner in the context of a stamping and bending process (or any other process). The design of the external element therefore does not have to be adapted as a function of the cable diameter. In this way, the metallic part of the support sleeve assembly. which is naturally the most complex and the most expensive to produce, can advantageously be produced as a non-variable part.

At the same time, the production of the plastics adapter element is able to be readily adapted to arbitrary cable diameters in a cost-effective manner, wherein material costs can in particular be saved in the case of large wall thicknesses, because the external element can continue to be designed as a thin sheet-metal part, while the adapter element having the more cost-effective plastics material can serve as a “filler element”.

As a result, a cost-effective stamping and bending process can moreover be optionally used for producing the external element, as has already been mentioned, as opposed to a time-consuming and cost-intensive turning process of the prior art.

In this way, by combining the metallic external element and the plastics adapter element, a modular support sleeve assembly can be provided, which can be readily adapted for use with almost any arbitrary cable diameters.

It is to be mentioned at this point that, in principle, a plurality of adapter elements can also be received in the common external element, or be fastened to the common external element (at least be fastened indirectly to the external element). For example, a plurality of adapter elements can be disposed in an annular manner inside one another, and/or distributed along the internal circumference of the external element. However, exactly one adapter element is preferably provided for the external element.

The adapter element is preferably not a cable component of the cable, but a component, which is independent of the cable, for fastening on the cable.

The external element is preferably designed so as to be exclusively partially annular, or tub-shaped. The external element preferably does not form a completely closed ring. The external element can be open or slotted at least at one position along the circumference, or at least have an interrupted cross section.

The support sleeve assembly, proceeding from a mechanically relaxed state, can be compressible, counter to an elastic restoring force, to an elastically pre-loaded state. In the elastically pre-loaded state, which hereunder is thus also referred to as the “compressed state”, the spacing between two mutually opposite reference points on an external shell face and/or internal shell face of the support sleeve assembly can be reduced in comparison to the spacing of the two reference points in the mechanically relaxed state. In the case of a partially annular, or annular/hollow-cylindrical support sleeve assembly, the external diameter and/or the internal diameter of the support sleeve assembly can thus be reduced, for example. It is to be mentioned at this point that in the context of the compression of the support sleeve described, a permanent or plastic deformation of the support sleeve may also be caused in addition to the elastic pre-load/restoring force. The compression of the support sleeve typically causes a plastically and elastically deformed compressed state,

In a refinement of the invention, it can be provided that the adapter element is composed at least substantially, preferably exclusively, of the plastics material (optionally however, additionally with the additive yet to be mentioned hereunder).

However, this does not preclude that there may optionally be even more constituent parts (but preferably less than 1 to 10%, particularly preferably less than 0.5 to 5%, furthermore preferably less than 0.5 to 2%), in particular such constituent parts which do not significantly change the substantial features of the adapter element (such as, for example, contaminations and/or residues of other materials).

It can be provided that the adapter element is of an integral, or a one-part design. In this way, the adapter element can be a single component. Optionally however, a multi-part adapter element can also be provided. for example an adapter element in two parts which is formed from two inter-connectable half shells.

It can be provided that the relaxation resistance and/or strength and/or temperature resistance and/or breakage resistance of the adapter element is increased by admixing at least one additive. In this context, relaxation describes the drop in tension in the support sleeve assembly, or the adapter element, in the course of time in the case of a preceding elongation or compression of the support sleeve assembly, or of the adapter element, respectively. Thus, relaxation describes the transition of the support sleeve assembly, or of the adapter element, back to the initial state or equilibrium state upon external excitation or disturbance.

The adapter element can preferably have particularly robust mechanical properties, and moreover be extraordinarily resistant to ageing. As a result, the overall mechanical properties of the support sleeve assembly can be improved by the proposed admixing of the additive to the adapter element.

It can be provided that the additive is in the form of fibres and/or spheres. In principle however, the additive may have arbitrary shapes or geometries.

The additive is preferably glass, carbon, aramid, metal (these may be pure metals or else alloys) and/or an organic material (e.g. resins, natural fibre materials, inter alia hemp). In principle, arbitrary inorganic or organic materials can be used as additives. In the context of the invention. combinations of a plurality of materials can moreover be referred to conjointly as “additive” in the context of the present invention.

It should be moreover mentioned that it can also be provided that the additive per se is a plastic, in particular a plastics material which is different from the aforementioned “plastics material” (meaning that a combination of two plastics materials may be provided in order to form the adapter element). However, the additive is preferably not a plastics material.

It can be provided that the adapter element comprises the additive in a proportion of 10% to 60%, preferably 20% to 50%, furthermore preferably 25% to 40%, particularly preferably 30% to 35%. The plastics material can particularly preferably comprise the additive in a proportion of at least substantially or exactly 30%. The ranges and ratios mentioned above have proven to be particularly advantageous.

Typically, however, it is preferable not to admix any additive to the plastics material of the adapter element, because the adapter element in its substantial function as a “filler material” also permits the use of comparatively cost-effective plastics materials without particular material properties. Furthermore, an additive may potentially increase the brittleness of the adapter element, which would impede the compression capability

In a refinement of the invention, it can be provided that the plastics material is polyamide (PA), polyetherimide (PEI), but preferably polypropylene (PP), polybutylene terephthalate (PBT) or polyethylene (PE), for example. In principle, however, even further plastics material may be suitable in the context of the invention. It is preferably a cost-effective and/or flexible plastics material which can be deformed over a large range The plastics material can potentially also be a (chemically or physically) expanded plastic foam material, or a foam material.

Soft or deformable plastics materials can in particular be suitable for forming the adapter element. The plastics material can preferably be able to be deformed or compressed over a large range, substantially without breaking.

It can be provided that a wall thickness of the adapter element corresponds to at least the wall thickness of the external element. preferably corresponds to at least 1.5 times the wall thickness, particularly preferably at least 2 times the wall thickness, most particularly preferably at least 5 times the wall thickness, even furthermore preferably at least 10 times the wall thickness, of the external element. In principle however, the wall thickness of the adapter element can also be smaller than the wall thickness of the external element.

The economic advantages of the proposed support sleeve assembly become particularly relevant in particular in the case of large wall thicknesses, because large wall thicknesses in the context of the invention can be enabled substantially by the adapter element and thus by the plastics material, instead of a solid turned metal part according to the prior art. In this way, the production can be more cost-effective and simpler. Furthermore, by means of the proposed support sleeve assembly, it is possible to also make wall thicknesses that cannot be implemented in the first place or assembled/crimped in a conventional way

In a refinement of the invention it can be provided that the adapter element has inner shell-proximal elevations, which are distributed along the internal circumference, for reducing the internal cross section.

These can be, for example, longitudinal ribs which are aligned in the axial direction, for example, and are preferably distributed along the internal circumference of the adapter element, for example so as to be equidistantly distributed. For example, the inner-shell-proximal elevations can however also be at least one inner ring which is at least partially encircling in the circumferential direction, wherein a plurality of at least partially encircling inner rings can be disposed so as to be spaced apart. or in the manner of a thread pitch, in the axial direction of the adapter element. In principle however, arbitrary inner-shell-proximal elevations can be provided in order to reduce the internal cross section of the adapter element.

By using the inner-shell-proximal elevations for reducing the internal cross section, material can be saved, and the economic viability of the production of the support sleeve assembly can be further improved in this way.

In a refinement of the invention, it can also be provided that the adapter element has inner-shell-proximal elevations, which are distributed along the internal circumference, for fixing in a form-fitting manner on the cable.

The inner-shell-proximal elevations for fixing in a form-fitting manner on the cable can be provided additionally or alternatively to the inner-shell-proximal elevations for reducing the internal cross section. Moreover, corresponding inner-shell-proximal elevations can simultaneously also be advantageously suitable for both uses, for example in the case of the longitudinal ribs by way of which improved fixing on the cable sheath of the cable, and simultaneously a reduction of the internal cross section, are made possible.

The at least one inner-shell-proximal elevation for fixing in a form-fitting manner can be, for example, ribs or barbs.

The inner-shell-proximal elevations can be particularly advantageous for better fixing of the support sleeve assembly on cable components of the cable, in that a form fit is used in addition to the force fit. In this way, the adapter element can be able to be better fixed on the cable sheath of the cable and/or a dielectric/isolator of the cable. The support sleeve assembly assembled on the cable can in this way be more resilient, in particular in the case of tension transverse to the cable and/or tension longitudinal to the cable.

In the refinement of the invention, it can be provided that the adapter element in a mechanically relaxed state is designed to be at least partially annular, or sleeve-shaped (with an optional longitudinal slot), and can be compressed into a mechanically stressed state. A spacing between two opposite points on a shell face (inner shell face or outer shell face) of the adapter element in the mechanically stressed state is preferably reduced in comparison to a spacing of said points in the mechanically relaxed state (in this way, the lateral transverse extent, or in the round case the diameter of the adapter element, can thus be reduced in the mechanically stressed or compressed state).

In the mechanically stressed state, the adapter element can be at least substantially closed in an annular or sleeve-shaped manner. However, the adapter element in the mechanically stressed state, or in the compressed state, does not necessarily have to be completely closed. In principle, a gap can remain between the mutually facing ends of the adapter element, or said ends may also still be mutually spaced apart when the support sleeve assembly is in its assembled state on the cable.

In particular, an adapter element which is completely closed along the circumference, thus an annular or sleeve-shaped adapter element (i.e. also already in the mechanically relaxed, non-assembled state), can also be provided. However, a completely annular or sleeve-shaped (non-slotted) adapter element is typically less preferable.

It is to be mentioned at this point that it is not a necessary requirement that the adapter element in the context of compressing or crimping the support sleeve assembly is brought to the compressed state in a non-destructive manner on the cable, or within the outer conductor contact element. It can also be provided that the at least one adapter element has in portions predetermined breaking points which snap in a defined manner in the context of the compression.

The compression capability can be improved, for example (but not as a necessary requirement) by using a plastics material with a preferably high elongation at breakage, or a high ductility, by using the longitudinal slots yet to be mentioned hereunder, or by using hinges (in particular integral hinges) which are disposed so as to be distributed along the circumference of the adapter element.

In a refinement of the invention, it can be provided that the adapter element has at least one longitudinal slot which extends in the axial direction at least partially through the adapter element.

It can be provided that exactly one longitudinal slot extends completely through the adapter element (for example, a C-shaped or partially annular adapter element can be provided as a result). Alternatively or additionally, it can however also be provided that one or a plurality of longitudinal slots extend only partially through the adapter element.

The achievable reduction of the diameter, thus the compression capability of the adapter element, can be improved by the at least one longitudinal slot, so that the adapter element is deformable over a greater range. This can improve the fixing or fastening of the adapter element (and thus of the entire support sleeve assembly) on the cable, in particular on the cable sheath of the cable.

It is to be mentioned at this point that in principle arbitrary slots/notches/recesses, which are disposed so as to be distributed over the circumference of the adapter element, can be provided as an alternative to the at least one longitudinal slot, so as to predefine the compression capability of the adapter element along its longitudinal extent.

It is to be mentioned at this point, however, that the adapter element does not necessarily have to be slotted.

In a refinement of the invention, it can be provided that the metal sheet of the external element is an aluminium sheet and/or steel sheet and/or titanium sheet and/or a sheet of a non-ferrous metal (such as, for example, copper, brass or bronze).

As has already been mentioned, the external element is preferably a component which is produced in the context of a stamping and bending method. In principle however, further production methods may also be suitable for forming the external element. Into alia, the external element can also be designed as a turned part, be deep-drawn or extruded. In particular when the external element is designed to be completely closed in an annular or sleeve-shaped manner, the adapter element in the context of further processing can be introduced axially into the completed external element. Alternatively (for example in particular in the case of a stamping and bending method), assembling of the adapter element can however also take place already before or partially during the production of the external element, thus for example before or during bending of the external element.

In a refinement of the invention, it can be provided that the external element in a pre-assembly state is formed to be partially annular or tub-shaped in such a manner that the external element in the context of an assembly procedure can be compressed to an assembly state in which the external element is at least substantially closed in an annular manner.

It can be provided in particular that the external element has a longitudinal slot, or an interrupted circumferential line, respectively.

It is to be mentioned at this point that it can in particular also be provided in the context of compressing the external element that the external element is “super compressed”, thus compressed to a greater extent than would actually be required for assembling in an associated outer conductor contact element, so that an advantageous force fit is created between the outer conductor contact element and the support sleeve, and a cable shield which is potentially to be fastened between the support sleeve and the outer conductor contact element, as a result of the elastic restoring force of the external element inherent in its material.

In the mechanically stressed state, or in the assembly state, the external element does not necessarily have to be completely closed, while this is preferable however. In principle, a gap can remain between the mutually facing ends of the external element, or said ends can still be mutually spaced apart even when the support sleeve assembly is situated in its assembled state on the cable, respectively. Typically however, it is provided that the mutually facing ends of the external element in the compressed, or assembled, state of the support sleeve assembly are in contact, or there is direct mechanical contact between them, respectively.

The support sleeve assembly, in particular the external element and/or the at least one adapter element, can in principle have any arbitrary cross section. Preferably, the cross section (in the assembly state) is at least substantially elliptic, in particular at least substantially round. However, the cross section may also be rectangular. In particular, arbitrary polygonal cross-sectional geometries may be provided. The cross section of the external element and/or of the adapter element can optionally also be non-symmetrical in terms of its central axis, and vary (for example taper) along the longitudinal axis.

In a refinement of the invention, it can be provided that the external element has on a first side end a fixing means in the circumferential direction, and has on an opposite, second side end a mating fixing means in the circumferential direction.

In the assembly state of the external element, the fixing means and the mating fixing means preferably form at least an axial form fit. Additionally or alternatively, a radial form fit and/or a form fit in the circumferential direction can also be provided.

The fixing means and the mating fixing means are preferably designed in such a manner that they engage in one another in the assembly state of the external element.

It can be provided in particular that the fixing means has one tooth or a plurality of teeth or comparable extensions/elevations, and that the mating fixing means form suitable depression/receptacles for the tooth, or the teeth. A single tooth, which engages in a tooth-gap-shaped recess, can already generate an advantageous axial form fit.

It can be provided for example, inter alia, for generating an axial form fit and a form fit in the circumferential direction, that the fixing means and the mating fixing means are designed in the manner of “puzzle parts”.

It can also be provided that the first side end and the second side end of the external element are designed so as to latch into one another in the assembly state of the external element, so that any springback of the external element is blocked at least in regions. However, it can also be provided specifically that the external element springs back in the assembly state, so as to improve the fixing of the cable shield between the outer shell face of the external element and an inner shell face of the outer conductor contact element of the plug connector.

In a refinement of the invention, it can be provided that an inner shell face of the external element bears at least in portions directly on the outer shell face of the adapter element.

The inner shell face of the external element preferably bears on the full area on the external shell face of the adapter element. However, it can optionally also be provided that the adapter element has outer-shell-proximal elevations, and/or the external element has inner-shell-proximal elevations, such as longitudinal ribs, inner rings, webs, tabs, lugs, or the like, so that gaps remain between the outer shell face of the adapter element and the inner shell face of the external element at least in portions, in particular so as to further increase the effective wall thickness in a material-saving manner.

In a refinement, it can be provided that the adapter element is fastened to the external element in a form-fitting manner. For example, a mutually latching connection, which is formed by the adapter element and the external element, can be provided for the form-fitting fastening.

For example, it can be provided that the at least one adapter element has outer-shell-proximal latching elevations which are able to latch in corresponding latching recesses of the external element, or vice versa.

As a result, a circumferential and/or axial form-fit, which can be releasable if required, can in particular be provided as a result.

In an alternative or additional refinement, it can moreover be provided that the adapter element is fastened to the external element in a force-fitting manner. The adapter element can in particular be press-fitted in the external element.

In an alternative or additional refinement, it can moreover also be provided that the adapter element is fastened to the external element in a materially integral manner. For example, the adapter element can be adhesively bonded or welded to the external element at least in portions.

In principle, any arbitrary fastening technique can be provided for the adapter element in the external element; further examples include, inter alia, hot-riveting or clips.

In a refinement of the invention, it can be provided that the adapter element has, on a portion of the outer shell face (outer shell portion) facing away from a circumferential opening, a centring elevation, and that the external element has, on a portion of the inner shell face (inner shell portion) opposite a circumferential opening, a centring recess for the centring elevation of the adapter element, or vice versa.

The centring elevation can preferably be a centring dome, a centring pin or a centring web. The centric recess can preferably be a depression (for example a trough) or a cut-out or a bore.

The centring elevation can preferably be press-fitted in the centring recess, so as to generate a sufficient holding force between the adapter element and the external element already by assembling the adapter element in the external element. It can optionally also be provided that the centring elevation can be clipped into the centring recess.

It can also be provided that the centring elevation does not exit the centring recess on the rear side (therefore, the length/extent of the centring elevation is preferably smaller than, or equal to, the wall thickness of the external element).

It can be provided that the support sleeve assembly (in particular the external element and/or the at least one adapter element) have at least one profile which tapers at least in portions in the axial direction, in particular a profile which tapers in the direction towards the corresponding axial end of the support sleeve assembly in an axial end portion, or in both axial end portions, of the support sleeve assembly.

The compressive force for press-fitting or a crimping the support sleeve assembly to the outer conductor contact element, and/or the required deformation travel for the support sleeve assembly can be reduced as a result of a tapered profile, on account of which the mechanical requirements set for the support sleeve assembly may be reduced. A profile of the support sleeve assembly, which tapers at least in portions, can moreover be advantageous in order to generate an additional form fit during the later press-fitting or crimping to the outer conductor contact element, which may lead to an improved fixing of the support sleeve assembly including the outer conductor contact element on the cable, in particular to an improved fixing of the support sleeve assembly on the cable sheath of the cable.

The tapered profile can already be present in the mechanically relaxed state of the support sleeve assembly, or of the external element and/or of the adapter element. Alternatively or additionally, it can be provided that the tapered profile is generated by the compression of the support sleeve assembly. For this purpose, it can be advantageous (but not necessarily required), that the at least one adapter element and/or the external element have/has a plurality of longitudinal slots which are distributed along the circumference of the support sleeve assembly, and which extend in each case in the axial direction only in portions through the support sleeve assembly.

It can be provided that the support sleeve assembly has an at least partially annular collar which is formed on an axial end of the support sleeve assembly, or a plurality of collar segments which are disposed on the axial end of the support sleeve assembly so as to be distributed along the circumference, so as to form in each case a detent for a cable sheath of the cable. In this way, the support sleeve can be axially positioned optimally relative to the cable, or the cable sheath. The collar. or the collar segments can be formed on the external element and/or the at least one adapter element.

It can also be provided that a detent for the cable sheath of the cable is formed by an axial offset, or an axial step, between the adapter element and the external element, for example in such a manner that an end portion of an inner shell face of the external element is not covered by the adapter element. For this purpose, at least one axial end of the adapter element can be offset axially (preferably “inwardly ”) relative to the assigned axial end of the external element, for example in that the axial longitudinal extent of the adapter element is selected to be smaller than the axial extent of the external element. It can thus be provided that the end faces of the adapter element and of the external element are axially offset relative to one another, so as to form a detent for the cable sheath.

The invention also relates to a cable plug-connector arrangement, having a support sleeve assembly according to the above and following embodiments, and the cable, in particular an electrical or optical cable, preferably a high-voltage cable.

The support sleeve assembly is preferably disposed on an end portion of the electrical cable in such a way that an exposed portion of a cable shield of the cable is able to be positioned on an outer shell face of the external element (and preferably able to be clamped or crimped between the outer shell face of the external element and an inner shell face of the outer conductor contact element of the plug connector, which is yet to be mentioned hereunder).

Alternatively (and less preferably), it can also be provided however that the support sleeve assembly is disposed on a portion of the outer conductor contact element of the plug connector in such a way that an exposed portion of the cable shield of the cable is able to be positioned (and preferably able to be clamped or crimped in this arrangement) between an outer shell face of the outer conductor contact element and an inner shell face of the adapter element.

The support sleeve assembly is particularly advantageously suitable for use with high-voltage plug connectors, whereby the type of plug connector and type of cable, and their provided use, is not fundamentally relevant. Therefore, the support sleeve assembly can also be very suitable in particular for use in high-frequency engineering, thus for example for data plug connectors.

The proposed support sleeve assembly is particularly advantageously suitable for use with cables having cross sections of 6 to 1000 mm². preferably 8 to 250 mm², in particular preferably 16 to 120 mm². In principle, the invention is however suitable for use with cables having any arbitrary cross section.

In a refinement of the invention, it can be provided that the cable plug-connector arrangement has an outer conductor contact element of an electrical plug connector, which is press-fitted on the support sleeve assembly in such a manner that the cable shield is fixed between the outer shell face of the external element of the support sleeve assembly and an inner shell face of the outer conductor contact element.

The outer conductor contact element is preferably positioned on the support sleeve assembly in such a manner, and the support sleeve assembly and the outer conductor contact element are press-fitted, in particular crimped, to one another in such a manner, that the support sleeve assembly is compressed to its elastically pre-loaded state, and as a result the cable shield is fixed (in a force-fitting and/or force-fitting manner) between the support sleeve assembly and the outer conductor contact element.

The plug connector is not to be understood to be a mandatory part of the cable plug-connector arrangement. However, it can be provided that the cable plug-connector arrangement also has the plug connector.

The cable plug-connector arrangement can optionally have at least one inner conductor contact element which is electrically and mechanically connected (for example crimped) to at least one inner conductor of the cable. In principle, any arbitrary further components of a plug connector and/or of a cable may be provided in the context of the proposed cable plug-connector arrangement.

In order to improve the fixing between the outer conductor contact element and the support sleeve assembly, it can optionally be moreover provided that the outer conductor contact element has inner-shell-proximal elevations and/or depressions, and/or that the external element of the support sleeve assembly has outer-shell-proximal elevations and/or depressions, for example at least one inner-shell-proximal projection and/or offset, for example latching hooks, ribs, grooves and/or barbs.

It can be optionally provided that the support sleeve assembly has an at least partially annular flange formed on an axial end, or a plurality of flange segments which are disposed on the axial end of the support sleeve assembly so as to be distributed along the circumference (preferably distributed equidistantly along the circumference), so as to form in each case a detent for a plug-connector component or cable component (in particular a detent for the outer conductor contact element). In this way, the support sleeve assembly can be positioned optimally relative to plug-connector components and/or cable components. The flange, or the flange segments, can be formed by the external element and/or the adapter element.

Apart from being a detent for the outer conductor contact element or the cable sheath, a flange or a collar can moreover advantageously prevent that braid wires of the shield protrude from the plug connector after crimping or assembling. In this way, any risk of injury can be precluded by the flange or the collar (in particular when these are designed so as to be completely encircling and not just segments).

The invention also relates to modular system for assembling a support sleeve assembly according to the above and following embodiments. having a group of a plurality of different adapter elements which are designed so as to be functionally identical in portions, so that one of the adapter elements of the group is selectively able to be received within the external element and captively fastened to the external element. The adapter elements of the group have in each case different internal geometries for fastening onto cables with different cable diameters. As a function of the cable diameter, exactly one adapter element corresponding to the cable diameter is able to be combined in a modular manner with the external element so as to form a common support sleeve assembly.

By means of the modular system, a support sleeve assembly is advantageously provided, of which the component that is the most complex to produce (the external element) is able to be produced as a non-variable part. The external element is ultimately able to be adapted variably to different cable cross sections as a result of the adapter element, and conjointly with the selected adapter element forms a multi-part support sleeve (the aforementioned “support sleeve assembly”, which can be used in a conventional manner by a technician for assembling on the cable). The crimping process for fastening the support sleeve assembly on the cable therefore preferably does not differ from the crimping process of a conventional support sleeve, which is why the assembling can take place without adapting crimping tools to different cables.

Optionally, but not necessarily, the external element is a component of the system according to the invention. However, the system may also be suitable to be used with a corresponding external element.

The invention also relates to a method for assembling a support sleeve assembly for fastening on a cable, comprising at least the following method steps:
providing an at least partially annular external element formed from a metal sheet;
providing a group of a plurality of different adapter elements which comprise in each case a plastics material and are designed so as to be functionally identical in portions in such a way that optionally one of the adapter elements of the group is able to be received within the external element and able to be captively fastened to the external element, wherein the adapter elements have in each case different internal geometries for fastening onto cables with different cable diameters;
selecting exactly one of the adapter elements of the group that has a matching internal geometry for the cable diameter of the provided cable: and
fastening the external element on the selected adapter element.

Particularly economical and mass-production-capable support sleeves, or support sleeve assemblys, may be advantageously producible by the proposed method. Adapting the process to different cable cross sections can be particularly simple, for example in that the thickness of the adapter element, or the wall thickness of the adapter element, is correspondingly adapted.

It can be provided that the adapter element is produced in the context of an injection-moulding method. In principle however, other technologies may also be suitable for producing the proposed adapter element.

In the context of the method according to the invention, at least one of said adapter elements can be press-fitted in a stamped external element, the latter potentially having substantially the shape of a conventional support sleeve. This can preferably, but not necessarily, take place already at the stamping installation which is used for producing the external element.

The support sleeve assembly consisting of the external element and the adapter element received in the external element can be transferred to the fabricator for later assembling on the cable, for whom the further assembling/processing does not change in comparison to a conventional support sleeve.

The plastic adapter element can be advantageously used for compensating the spacing between the external element, thus the metallic component of the support sleeve assembly, and the typically smaller cable.

The invention moreover relates to an adapter element for a support sleeve assembly according to claim 1.

Moreover, the invention relates to the use of an adapter element comprising a plastics material (in particular according to the above and following embodiments) in a support sleeve assembly, wherein the adapter element is able to be received in an external element formed from a metal sheet and is able to be captively fastened to the external element.

Features which have been described in the context of one of the subjects of the invention, specifically provided by the support sleeve assembly according to the invention, the cable plug-connector arrangement according to the invention, the system according to the invention, the method according to the invention, the adapter element according to the invention, and the use according to the invention, can also be advantageously implemented for another subject matter of the invention. Likewise, advantages which have been mentioned in the context of one of the subjects of the invention can also be understood to relate to the other subjects of the invention.

In addition, it should be noted that terms such as “comprising”, “having” or “with” do not rule out other features or steps. Furthermore, terms such as “one”, “a/an” or “the”, which indicate a singular number of steps or features, do not rule out a plurality of features or steps—and vice versa.

In a puristic embodiment of the invention, provision may also be made, however, for the features introduced by the terms “comprising”, “having” or “with” in the invention to be exhaustively listed. Accordingly, one or a plurality of lists of features can be considered to be complete in the scope of the invention, for example considered for each claim in each case. The invention may, for example, consist only of the features mentioned in claim 1.

It should be noted that designations such as “first” or “second” etc, are primarily used for reasons of distinguishing between respective device or method features and are not necessarily intended to indicate that features are mutually dependent or are linked to one another.

It should also be noted that the values and parameters described herein include deviations or fluctuations of ±10% or less, preferably ±5% or less, more preferably ±1% or less, and very particularly preferably ±0.1% or less of the value or parameter mentioned in each case, as long as these deviations are not ruled out on implementing the invention in practice. The indication of ranges through the use of starting and end values also includes all those values and fractions that are included by the range mentioned in each case, in particular the starting and end values and a respective mean value.

The invention also relates to a support sleeve assembly which is independent of claim 1, having an external element which comprises a metallic material, and at least one adapter element comprising a plastics material, wherein the at least one adapter element is at least in portions received within the external element. The further features of claim 1 and of the further claims, and the features described in the present description, relate to advantageous embodiments and variants of this support sleeve assembly, for which the applicant expressively reserves the right to claim separately.

Exemplary embodiments of the invention will be described in more detail hereunder by means of the drawings.

The figures each show preferred exemplary embodiments, in which individual features of the present invention are illustrated in combination with one another. Features of one exemplary embodiment are also able to be implemented separately from the other features of the same exemplary embodiment and can accordingly be readily combined with features of other exemplary embodiments by a person skilled in the art to form further meaningful combinations and sub-combinations.

In the figures, functionally identical elements are provided with the same reference signs.

In each case schematically:

FIG. 1 shows a support sleeve assembly according to a first exemplary embodiment of the invention, in a preassembled state, in a perspective illustration;

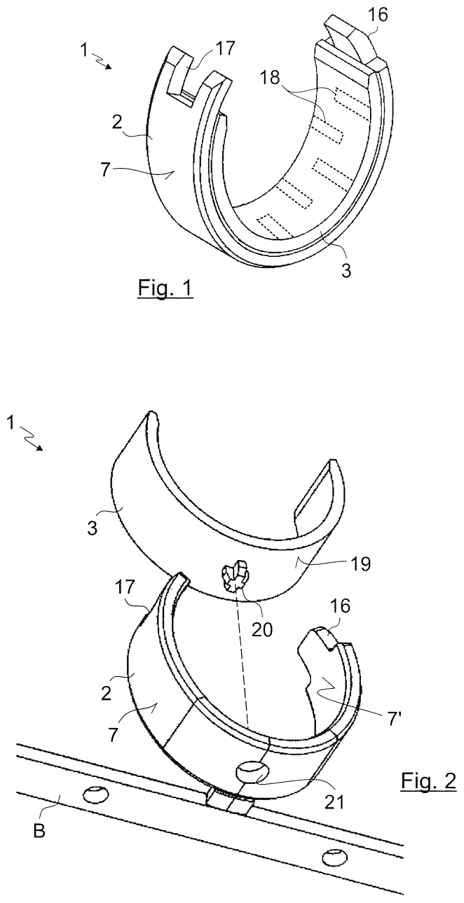

FIG. 2 shows the support sleeve assembly according to FIG. 1 in a not yet assembled state, in a perspective illustration;

FIG. 3 shows a cable plug-connector arrangement according to an exemplary embodiment of the invention, having a support sleeve assembly fastened on the cable, in a longitudinal sectional illustration:

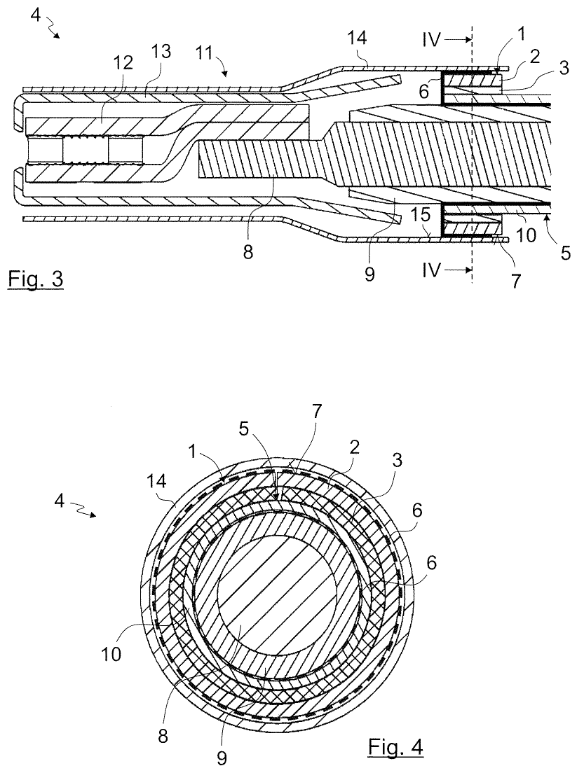

FIG. 4 shows the cable plug-connector arrangement of FIG. 3 in a cross section along the section line IV-IV;

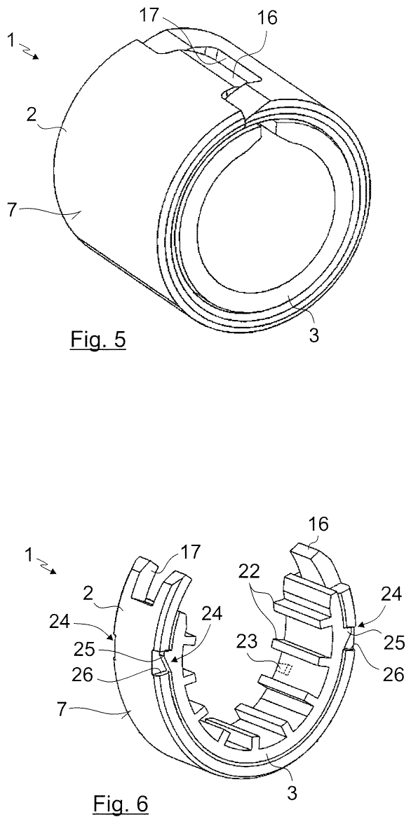

FIG. 5 shows the support sleeve assembly according to FIG. 1 in a compressed state, in a perspective illustration;

FIG. 6 shows a support sleeve assembly according to a second exemplary embodiment of the invention, in a preassembled state, in a perspective illustration;

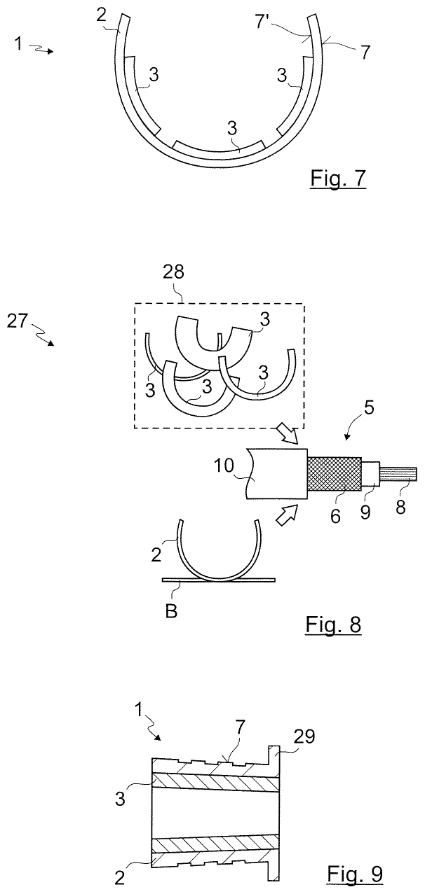

FIG. 7 shows a support sleeve assembly according to a third exemplary embodiment of the invention, in a preassembled state, in a frontal view;

FIG. 8 shows a modular system for assembling a support sleeve assembly according to the invention; and

FIG. 9 shows an exemplary embodiment for a support sleeve assembly having a detent region/flange.

FIG. 1 shows a support sleeve assembly 1 according to the invention, and according to a first exemplary embodiment of the invention, in a preassembled state. A not yet assembled state of the support sleeve assembly 1 is illustrated in FIG. 2.

The support sleeve assembly 1 has an external element 2 which is formed from a metal sheet, and an adapter element 3 which comprises at least one plastics material. The at least one adapter element 3 is received within the external element 2 and is captively fastened to the external element 2.

The external element 2 is formed so as to be at least partially annular or tub-shaped, respectively, and is preferably designed as a stamped and bent part. By way of example, FIG. 2 illustrates the (continuous) tape material B from which the external element 2 can be singularised after completing the stamping and bending process; this may selectively take place already before or only after assembling the adapter element 3.

The proposed support sleeve assembly 1 is suitable for use in a cable plug-connector arrangement 4 for fastening on a cable 5, in particular on an electric cable 5 for high-voltage engineering. By way of example, a corresponding cable plug-connector arrangement 4 according to the present invention is illustrated in a longitudinal section in FIG. 3, and in a cross section in FIG. 4. The support sleeve assembly 1 is disposed in the cable plug-connector arrangement 4 on an end portion of the electric cable 5 in such a way that an exposed portion of the cable shield 6 of the cable 5 is positioned on an outer shell face 7 of the external element 2.

By way of example, the electrical cable 5 is a coaxial cable. The electrical cable 5 has an inner conductor 8 which is encased by a dielectric 9, a cable shield 6 extending on the latter. In the exemplary embodiment, the cable shield 6 is a braided cable shield formed from a plurality of individual wires. An electrically isolating cable sheath 10 extends about the cable shield 6. As illustrated, the electrical cable 5 is stripped in portions, so as to render of the inner conductor 8 and the cable shield 6 accessible for fabrication with an electrical plug connector 11 (cf. FIG. 3; cf, also FIG. 8). The inner conductor 8 of the cable 5 is compacted so as to be plate-shaped, and is connected to an inner conductor contact element 12 of the plug connector 11, for example welded to the latter, whereby the specific type of connection between the inner conductor 8 and the inner conductor contact element 12 is not necessarily relevant in the context of the invention. The inner conductor contact element 12 of the plug connector 11 is at least partially surrounded by an isolator element 13 so as to provide a touch protection and an electrical separation between an outer conductor contact element 14 of the plug connector 11 and the inner conductor contact element 12.

The outer conductor contact element 14 of the electrical plug connector 11 is press-fitted on the support sleeve assembly 1 in such a manner that the cable shield 6 is fixed between the outer shell face 7 of the external element 2 of the support sleeve assembly 1 and an inner shell face 15 of the outer conductor contact element 14. In the context of this fixing operation, which preferably takes place by a crimping process, the external element 2, proceeding from its pre-assembly state illustrated in FIG. 1, can be compressed to an assembly state in which the external element 2 is at least substantially closed in an annular manner, as illustrated in FIG. 5. At the same time, the adapter element 3, which is disposed in the external element 2, is compressed from a mechanically relaxed state (cf. FIG. 1) to a mechanically stressed state, preferably (but not necessarily) in an non-destructible manner, in which the adapter element 3 is also at least substantially closed in an annular manner. As is indicated by means of FIG. 5, it is not required that the adapter element 3 and/or the external element 2 are/is completely closed—in this way, a gap may remain between the two ends of the adapter element 3 and/or of the external element 2 that point towards one another.

In its assembled state, the external element 2 furthermore has a longitudinal slot, or an interrupted circumferential line, respectively, wherein, in the assembled state, the side ends of the external element 2 preferably at least touch.

The external element 2 has, on a first side end a fixing means 16 in the circumferential direction, and has on an opposite second side end a mating fixing means 17 in the circumferential direction, said fixing means 16, 17 in the assembled state of the external element 2 forming an axial form fit. By way of example, in the exemplary embodiments the fixing means 16 is designed as a tooth, and the mating fixing means 17 is designed as a tooth-gap-like receptacle for the tooth.

The “toothing” of the external element 2 on its side ends in the compressed state can in particular also be advantageous in order to prevent that individual wires of the cable shield 6 of the cable 5 penetrate the longitudinal slot. Alternatively or additionally, it can also be prevented by means of the adapter element 3 that individual wires of the cable shield 6 enter, for example when the adapter element 3 is also toothed in the circumferential direction on corresponding side ends, or when the adapter element 3 is twisted within the external element 2 in such a manner that the longitudinal slots of the external element 2 and of the adapter element 3 do not lie directly “on top of one another”.

The metal sheet of the external element can be, for example, a copper sheet, an aluminium sheet, a brass sheet, a bronze sheet, a titanium sheet and/or steel sheet. The adapter element 3 is preferably composed exclusively, or at least substantially, of the plastics material. The plastics material can be, for example, polypropylene, polybutylene terephthalate or polyethylene.

It can optionally be provided that the adapter element 3 has at least one longitudinal slot 18 which extends in the axial direction at least partially through the adapter element 3, as is indicated by way of example in FIG. 1. The compression capability of the support sleeve assembly 1. or of the adapter element 3, can be improved in this way.

The inner shell face 7′ (cf. FIG. 2) of the external element 2 preferably bears at least in portions directly on the outer shell face 19 (cf. FIG. 2) of the adapter element 3, as is illustrated in the exemplary embodiments. The fastening of the adapter element 3 to the external element 2 can take place in a form-fitting, force-fitting and/or materially integral manner.

The adapter element 3 can have, on a portion of the outer shell face 19 facing away from a circumferential opening, a centring elevation 20, for example a centring dome (cf. FIG. 2) The external element 2 can have, on a portion of the inner shell face 7′ opposite a circumferential opening, a corresponding centring recess 21, for example a cut-out, as Illustrated in FIG. 2. The centring elevation 20 and the centring recess 21, or the centring dome and the cut-out, respectively, can be designed to establish a force-fitting and/or form-fitting connection between the adapter element 3 and the external element 2.

A second exemplary embodiment of a support sleeve assembly 1 is Illustrated in FIG. 6. The exemplary embodiment of FIG. 6 corresponds substantially to the first exemplary embodiment already discussed, which is why the differences will be substantially explained hereunder. The features of the exemplary embodiments are fundamentally also able to be combined with one another in an arbitrary manner, unless this is technically not precluded (this of course applies also to all exemplary embodiments discussed above and hereunder).

In order to increase the wall thickness of the support sleeve assembly 1. the adapter element 3 has inner-shell-proximal elevations, which are distributed along the internal circumference, and in the exemplary embodiment of FIG. 6 are designed as longitudinal ribs 22. Alternatively or additionally, inner-shell-proximal elevations can also contribute towards improving the fixing of the support sleeve assembly 1 on the cable 5, for example towards the form-fitting fixing on the cable sheath 10 of the cable 5. The illustrated longitudinal ribs 22 may likewise be suitable for this purpose, and alternatively or additionally however also barbs 23 (cf. dashed lines in FIG. 6), for example, or similar.

As has already been mentioned above, the fastening of the adapter element 3 in the external element 2 can fundamentally be of any arbitrary design. Optionally, corresponding fastening can take place already solely by assembling the adapter element 3 in the external element 2, and/or in combination with the centring elevation 20 and the centring recess 21. Additionally however, it can be provided in particular that the adapter element 3 and the external element 2 form a mutual latching connection 24. As proposed in FIG. 6, the adapter element 3 can have latching elevations 25 on its outer shell face 19, for example, and the external element 2 can have corresponding latching recesses 26 on its inner shell face 7′. A circumferential and axial form fit can be provided as a result, which is releasable if required.

It is also to be highlighted by means of a further exemplary embodiment according to FIG. 7, that the support sleeve assembly 1 can optionally also have more than one adapter element 3, for example three adapter elements 3 as illustrated. The plurality of adapter elements 3 can be directly adjacent to one another, or be disposed so as to be mutually spaced apart, as is the case in FIG. 7. Each of the adapter elements 3 can be captively fastened to the external element 2, for example latched or adhesively bonded thereto. A compression capability of the support sleeve assembly 1 over a wide range can optionally be made possible by using a plurality of adapter elements 3.

A modular system 27 for assembling a support sleeve assembly 1 is schematically indicated in FIG. 8. The system 27 can have a group 28 of a plurality of different adapter elements 3, which are designed so as to be functionally identical in portions in such a way that selectively one of the adapter elements 3 of the group is able to be received within a common external element 2 and is able to be captively fastened to the external element 2. The adapter elements 3 of the group 28 can in each case have different internal geometries for fastening onto cables 5 with different cable diameters. In this way, exactly one of the adapter elements 3 of the group 28 with a matching internal geometry for the cable diameter of the provided cable 5 can in each case be selected and fastened in the external element 2.

The invention is fundamentally suitable in particular when the difference in cross section between the external element 2 and the cable 5 to be used is comparatively large, so that the cross-sectional adaptation can take place by a correspondingly large wall thickness of the adapter element 3, the latter being significantly more economical to produce than producing a corresponding support sleeve according to the prior art. In this way, the wall thickness of the adapter element 3 can preferably (but not necessarily) correspond to at least the wall thickness of the external element.

A further advantage of the proposed support sleeve assembly 1 can be that an existing type of plug connector can be able to be adapted to different cable cross sections solely by selecting/changing the adapter element 3 of the support sleeve assembly 1.

A few further optional features of the proposed support sleeve assembly 1 are to be presented by way of example in FIG. 9.

First, FIG. 9 by way of example shows a taper of the support sleeve assembly 1, proceeding from an axial end (a taper in the direction towards the other end, a taper in the direction towards both ends, or a taper in a central axial portion can likewise be provided). The taper can already be present in the mechanically relaxed state, and/or be introduced in the context of assembling/press-fitting the external element 2 and the adapter element 3, and/or in the context of assembling/press-fitting the support sleeve assembly 1 in the outer conductor contact element 14. Longitudinal slots 18 or other material recesses in the external element 2 and/or in the adapter element 3 can be advantageous (but not necessarily required) for introducing the taper.

For improving the fixing action between the outer conductor contact element 14 and the support sleeve assembly 1, it can optionally be moreover provided that the outer conductor contact element 14 has inner-shell-proximal elevations and/or depressions (not illustrated in the figures). Alternatively or additionally, it can be provided that the external element 2 of the support sleeve assembly 1 has outer-shell-proximal elevations and/or depressions, as is indicated by way of example in FIG. 9. The improvement measures mentioned are of course able to be implemented independently of the taper likewise illustrated in FIG. 9, or of other features of FIG. 9.

It can optionally be provided that the support sleeve assembly 1 has an at least partially annular flange 29 on an axial portion (in particular on an axial end), or a plurality of flange segments (not illustrated) distributed along the circumference, so as to in each case form a detent region for a plug-connector component or cable component, in particular a detent for the outer conductor contact element 14. In this way, the support sleeve assembly 1 can be positioned optimally relative to the plug-connector component and/or cable component, in particular relative to the outer conductor contact element 14. It can also be advantageously prevented by the flange 29 that individual wires of the cable shield 6 exit the cable plug-connector arrangement 4. The flange 29 or the flange segments can be formed by the external element 2 and/or the adapter element 3 (purely by way of example, the flange 29 in the exemplary embodiment of FIG. 9 is formed by the external element 2). The flange 29, or the flange segments, or the detent region, respectively, is of course also able to be implemented independently of the taper likewise illustrated in FIG. 9 or of other features of FIG. 9.

1. A support sleeve assembly (1) for fastening on a cable (5), in particular on an electrical cable (5) for high-voltage engineering, the support sleeve assembly (1) comprising:
an external element (2) which is formed from a metal sheet, and is formed so as to be at least partially annular; and
at least one adapter element (3) comprising a plastics material; and wherein
the at least one adapter element (3) is received within the external element (2) and the at least one adapter element (3) is captively fastened to the external element (2).

2. The support sleeve assembly (1) as claimed in claim 1 and wherein that the adapter element (3) is composed exclusively of plastics material.

3. The support sleeve assembly (1) as claimed in claim 1 and wherein the plastics material is polypropylene. polybutylene terephthalate or polyethylene.

4. The support sleeve assembly (1) as claimed in claim 1 and further comprising:
inner-shell-proximal elevations on the adapter element (3), and the inner-shell proximal elevations are distributed about an internal circumference of the adapter unit (3), for reducing an internal cross section and/or for form-fitting fixing on the cable (5).

5. The support sleeve assembly (1) as claimed in claim 4 and wherein the inner-shell-proximal elevations are designed as longitudinal ribs (22), internal rings and/or barbs (23) which are at least partially encircling in a circumferential direction.

6. The support sleeve assembly (1) as claimed in claim 1 and wherein the adapter element (3), in a mechanically relaxed state, is at least partially annular, and the adapter element (3) can be compressed into a mechanically stressed state in which a spacing between two opposite points on a shell face of the adapter element (3) is reduced in comparison to the spacing of said points in the mechanically relaxed state.

7. The support sleeve assembly (1) as claimed in claim 1 and further comprising:
at least one longitudinal slot (18) defined in the adapter element (3); and
the at least one longitudinal slot (18) extends at least partially through the adapter element (3) in an axial direction.

8. The support sleeve assembly (1) as claimed in claim 1 and wherein the metal sheet of the external element (2) is aluminium sheet and/or steel sheet and/or titanium sheet and/or a sheet of non-ferrous metal.

9. The support sleeve assembly (1) as claimed in claim 1 and wherein the external element (2), in a pre-assembly state, is partially annular; and
the external element (2), in the context of an assembly procedure, can be compressed to an assembly state in which the external element (2) is at least substantially closed in an annular manner.

10. The support sleeve assembly (1) as claimed in claim 1 and wherein the external element (2) has a longitudinal slot, or has an interrupted circumferential line.

11. The support sleeve assembly (1) as claimed in claim 9 and wherein the external element (2) has on a first side end a fixing means (16) in the circumferential direction; and
the external element (2) has on an opposite second side end a mating fixing means (17) in the circumferential direction; and wherein
the fixing means (16) and the mating fixing means (17) in the assembly state of the external element (2) form an axial form fit.

12. The support sleeve assembly (1) as claimed in claim 1 and wherein an inner shell face (7′) of the external element (2) bears, at least in portions, directly on an outer shell face (19) of the adapter element (3).

13. The support sleeve assembly (1) as claimed in claim 1 and wherein the adapter element (3) is fastened to the external element (2) in a form-fitting manner.

14. The support sleeve assembly (1) as claimed in claim 1 and wherein the adapter element (3) is fastened to the external element (2) in a force-fitting manner.

15. The support sleeve assembly (1) as claimed in claim 1 and wherein the adapter element (3) is fastened to the external element (2) in a materially integral manner.

16. The support sleeve assembly (1) as claimed in claim 1 and further comprising:
an outer shell portion (19) of the adapter element (3) facing away from a circumferential opening of the adapter element (3); and
a centring elevation (20), preferably a centring dome, a centring pin or a centring web is carried on the outer shell portion (19) of the adapter element (3) and facing away from the circumferential opening; and
an inner shell portion (7′) of the external element (2), and the inner shell portion (7′) defines a centring recess (21) or a cut-out opposite a circumferential opening of the external element (2); and
the centring recess (21), or cut-out defined in the inner shell portion of the external element (2)receives the centring elevation (20) of the adapter element (3).

17. A cable plug-connector arrangement (4) comprising:
a support sleeve assembly (1) for fastening on a cable (5), in particular on an electrical cable (5) for high-voltage engineering, the support sleeve assembly (1) having,
an external element (2) which is formed from a metal sheet, and is formed so as to be at least partially annular, and
at least one adapter element (3) comprising a plastics material, and the at least one adapter element (3) is received within the external element (2), and
the at least one adapter element (3) is captively fastened to the external element (2); and wherein
the support sleeve assembly (1) is disposed on an end portion of the cable (5) in such a way that an exposed portion of a cable shield (6) of the cable (5) is able to be positioned on an outer shell face (7) of the external element (2).

18. The cable plug-connector arrangement (4) as claimed in claim 17 and further comprising:
an electrical plug connector (11) having an outer conductor contact element (14); and
the outer conductor contact element (14) of the electrical plug connector (11) is press-fitted on the support sleeve assembly (1) in such a manner that the cable shield (6) is fixed between the outer shell face (7) of the external element (2) of the support sleeve assembly (1) and an inner shell face (15) of an outer conductor contact element (14).

19. A modular system (27) for assembling a support sleeve assembly (1), the modular system (27) comprising:
a support sleeve assembly (1) for fastening on a cable (5), in particular on an electrical cable (5) for high-voltage engineering, the support sleeve assembly (1) having an external element (2) which is
formed from a metal sheet, and is formed so as to be at least partially annula; and
a group (28) of a plurality of different adapter elements (3) which are designed to be functionally identical in portions in such a way that selectively one of the adapter elements (3) of the group (28) is able to be received within the external element (2) and is able to be captively fastened to the external element (2); and wherein
the adapter elements (3) of the group (28) each have in each case different internal geometries for fastening onto cables (5) with different cable diameters; and wherein
as a function of the cable diameter, exactly one adapter element (3) of the group (28), corresponding to the cable diameter is able to be combined in a modular manner with the external element (2) so as to form a common support sleeve assembly (1).

20. Method A method for assembling a support sleeve assembly (1) for fastening on a cable (5), the method comprising the steps:
providing an at least partially annular external element (2) formed from a metal sheet;
providing a group (28) of a plurality of different adapter elements (3) which comprise in each case a plastics material and the plurality of different adapter elements (3) are designed so as to be functionally identical in portions in such a way that selectively one of the adapter elements (3) of the group (28) is able to be received within the external element (2) and is able to be captively fastened to the external element (2), and wherein the adapter elements (3) have, in each case, different internal geometries for fastening onto cables (5) that have different cable diameters; and
selecting exactly one of the adapter elements (3) of the group (28) that has a matching internal geometry for the cable diameter of the provided cable (5); and
fastening the external element (2) on the selected adapter element (3).

21. The support sleeve assembly (1) as claimed in claim 1 and wherein the adapter element (3) is fastened to the external element (2) by a mutual latching connection (24) formed by the adapter element (3) and by the external element (2).

22. The support sleeve assembly (1) as claimed in claim 1 and wherein the adapter element (3) is pressed into the external element (2).

23. The support sleeve assembly (1) as claimed in claim 1 and wherein the adapter element (3) is, at least in portions, adhesively bonded or welded to the external element (2).
